(19) United States
(12) Patent Application Publication
(10) Pub. No.: US 2008/0032030 A1
(43) Pub. Date: Feb. 7, 2008

(54) Method and Apparatus for Producing Beverages from Coffee Beans Using Ultrasound Energy

(76) Inventor: Eilaz Babaev, Minnetonka, MN (US)

Correspondence Address: Bacoustics, LLC, 5929 BAKER ROAD, SUITE 470, MINNETONKA, MN, 55345, US

(21) Appl. No.: 11/464,518

(22) Filed: Aug. 15, 2006

(51) Int. Cl. A23F 5/00

(52) U.S. Cl. 426/594

(57) ABSTRACT

Method and device for producing beverages from coffee beans using ultrasound energy is disclosed. Ultrasonic energy is delivered to coffee beans to produce an improved coffee beverage. The use of ultrasound energy may have multiple effects such as the extraction of flavor solutes from the coffee beans or the sanitization of the resulting beverage. Ultrasound energy may also be used to help mix milk with espresso in order to produce a cappuccino or a latte; the ultrasound energy may also heat the milk or produce a milk froth. The use of ultrasound energy to produce beverages from coffee beans may result in a more flavorful and safer beverage for consumption.

### BACKGROUND OF THE INVENTION

1. Field of the Invention

The present invention relates to a method and apparatus for producing beverages from coffee beans using ultrasound energy.

2. Description of the Related Art

Coffee beans are used in the production of coffee and other related beverages. As used herein, the term ‘coffee beans’ refers to coffee beans, coffee grounds, or any other form or derivative of the seeds from a coffee plant including dehydrated and freeze dried coffees.

Coffee may be produced from coffee beans in several different manners. First, coffee may be brewed by dripping hot water over coffee beans that sit on a coffee filter. The water passes through the coffee beans, extracting solutes and oils from the beans, and the filter, and then drips into the coffee pot (hereafter referred to as the “drip brew method”). Secondly, coffee can be prepared by boiling water containing coffee beans in a pot or it can be prepared by pouring boiling water over the coffee beans (collectively referred to hereafter as the “boiling method”). Instant coffee, prepared in a manner similar to the boiling method of brewing coffee, is where hot water is poured onto dehydrated coffee, instead of coffee beans, as to dissolve the dehydrated coffee.

Espresso is another coffee beverage that is brewed using finely ground coffee beans. Rather than dripping hot water over coffee beans, hot water and/or steam is forced under high pressure through the coffee beans. Cappuccinos and/or lattes may be prepared using espresso in combination with milk. Espresso is poured into a cup and then milk is poured on top of the espresso. Frothed milk is then added to the top of the beverage. Milk is generally frothed via a steam nozzle inserted into the milk. The steam is turned on to both steam heat the milk while at the same time creating a milk froth on the top. The milk may be steamed either when it is in a cup with the espresso or it may be steamed in a separate pitcher before being mixed with the espresso.

U.S. Pat. No. 4,983,412 to Hauslein discloses a device to brew coffee and tea by moving the filter while brewing the coffee or tea. U.S. Pat. No. 4,779,520 to Hauslein also discloses a method and device for producing aqueous extracts from coffee by stirring the coffee and water during brewing. Hauslein utilizes different methods and devices, including ultrasound waves, to move the filter and to stir the coffee. This method and device can produce a beverage that has only a limited flavor because it does not utilize the sonication benefits of ultrasound energy to extract flavor containing and/or enhancing solutes and oils from the coffee beans.

Sanitizing the resulting beverage primarily by the heat, if any, produced during the brewing process, the previously mentioned methods for the preparation of coffee beverages remove limited amounts of bacteria, parasites, and other potentially harmful microorganisms. Increasing the temperature of the water utilized during the mentioned brewing processes will remove more microorganisms from the resulting beverage. However, the beverage often becomes too hot to safely or comfortably drink.

The problem with the traditional preparation and brewing methods is that they are only able to extract a limited amount of the flavor from the coffee beans and offer limited sanitization of the resulting beverage. Therefore, there is a need for a method and apparatus that is able to extract a greater amount of flavor from coffee beans and sanitize, without over heating, the resulting beverage.

### SUMMARY OF THE INVENTION

The present invention is directed towards a method and apparatus for producing beverages from coffee beans using ultrasound energy. Methods and apparatuses in accordance with the present invention may meet the above-mentioned needs and also provide additional advantages and improvements that will be recognized by those skilled in the art upon review of the present disclosure.

The present invention is an ultrasound apparatus comprised of an ultrasound generator, a transducer cable, an ultrasound transducer, an ultrasound horn, and an ultrasound tip. The ultrasound apparatus delivers ultrasound energy to produce beverages from coffee beans. The ultrasound apparatus may be used in conjunction with the drip brew method to brew coffee. The ultrasound horn may be positioned where the water drips onto the coffee beans; while the water drips, the horn sonicates the water and coffee beans. The ultrasound apparatus may also deliver ultrasound energy while pressurized water is delivered to coffee beans to produce espresso. The ultrasound apparatus may further be used to deliver ultrasound energy to a cup containing espresso and milk to produce cappuccino. Sonicating the cup may have effects such as mixing the espresso and milk, heating the milk, or creating milk froth, or any combination thereof. The ultrasound horn may also be inserted into a cup containing instant coffee and water; the horn sonicates the water and instant coffee mixture in order to extract more flavor from the coffee than traditional stirring by better dissolving, suspending, and dispersing the instant coffee within the water.

Exposing the coffee beans to ultrasound energy, the present invention extracts significant flavor from the beans by cavitating the beans. Cavitating the coffee beans further grinds the beans thereby increasing the surface area available for the transfer of oils and flavorful solutes from the beans into the water employed during the brewing process. Furthermore, cavitation of the beans liberates flavorful solutes and oils from the beans.

Exposing the beverage to ultrasound during the brewing the process the present invention destroys potential harmful microorganisms thereby sanitizing the beverage. The ultrasonic sanitization is not heat dependent. Therefore, the methods and apparatuses of the present invention allow the resulting beverage to be sanitized without it becoming too hot to safely or comfortably drink.

The ultrasound tip may remain in the same position or it may move during the delivery of ultrasound energy. The use of ultrasound energy in the production of beverages from coffee beans may have multiple effects such as producing more flavorful and sanitary beverages. The methods described above are only illustrative examples of methods to produce beverages from coffee beans using ultrasound energy; ultrasound energy may be used to produce other beverages from coffee beans and it may do so in other manners.

The invention is related to a method and device for producing beverages from coffee beans using ultrasound energy.

One aspect of this invention may be to provide a method and apparatus for producing beverages from coffee beans more quickly.

Another aspect of the invention may be to provide a method and apparatus that sanitize coffee beverages.

Another aspect of the invention may be to provide a method and apparatus for producing better milk froth.

These and other aspects of the invention will become more apparent from the written descriptions and figures below.

### BRIEF DESCRIPTION OF THE DRAWINGS

The present Invention will be shown and described with reference to the drawings of preferred embodiments and clearly understood in details.

FIG. 1 is a flow chart detailing a process for producing beverages from coffee beans.

FIG. 2 is a perspective view of an ultrasound apparatus for producing beverages from coffee beans.

FIG. 3 is a cross-sectional view of the ultrasound apparatus for producing beverages from coffee beans.

FIG. 4 is a schematic cross-sectional view of an ultrasound method and device for the production of beverages from coffee beans.

FIG. 5 is a cross-sectional view of an ultrasound apparatus sonicating a mixture of espresso and milk in order to produce cappuccino.

FIG. 6 is an alternative embodiment of the present invention in which a French press, or coffee press, has been adapted to incorporate the present invention.

### DETAILED DESCRIPTION OF THE INVENTION

The present invention is methods and apparatuses for producing beverages from coffee beans by using ultrasound energy. Preferred embodiments of the present invention in the context of methods and apparatuses are illustrated in the figures and described in detail below.

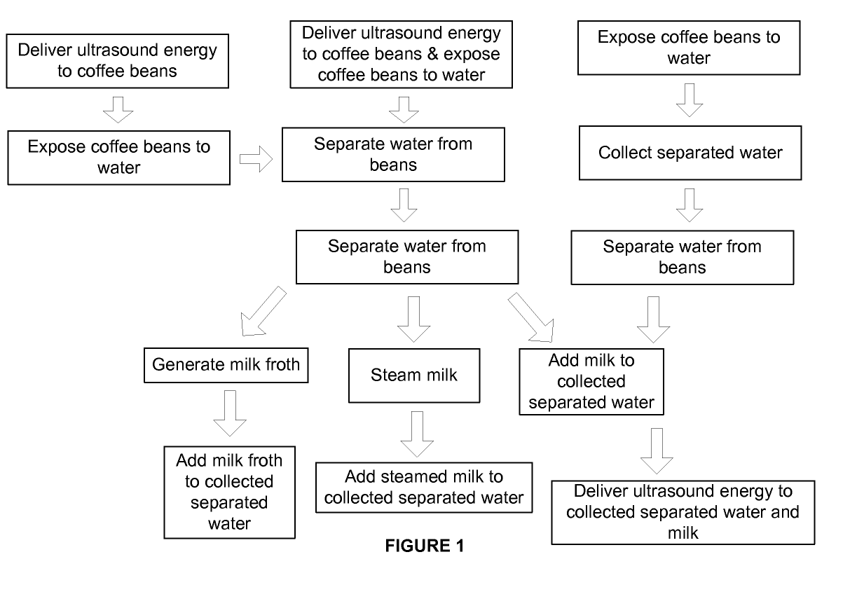

Utilizing the method of the present invention, a beverage produced from coffee beans can be created as depicted by the flow chart of FIG. 1 and described in detail herein. The process begins by first delivering ultrasound energy to coffee beans. The coffee beans are then exposed to water. Exposure to water includes, but is not limited to, pouring water over or onto the coffee beans, adding the coffee beans to water, filtering water through or across the coffee beans, forcing pressurized water or steam through or across the coffee beans, or any combination thereof. Alternatively, the exposure of coffee beans to water may occur simultaneously with the delivery of ultrasound energy to the coffee beans. The water is then separated from the coffee beans. Filtration is the preferred method of separating the water from the coffee beans. However, over methods of separation may be equally as effective. The separated water is then collected. If the coffee beans utilized in the process are capable of dissolving in water then separating the water from the coffee beans will not be necessary. At this point, a simple beverage has been produced. Employing further processing yields the creation of a more complex beverage. Generating milk froth and then adding the froth to the separated water collected may be done to produce a cappuccino like beverage. Milk froth may be generated by delivering ultrasound energy to the milk. Alternatively, milk forth may be created by steaming the milk. Steaming milk and then adding said steamed milk, excluding any froth produced, may be done to produce a latte like beverage. Adding simple milk to the separated water collected may be done to produce a coffee with cream. Additionally, ultrasound energy may be delivered to the milk and collected separated water to mix the milk and separated water and/or to produce milk froth. Milk, as used herein, refers to any dairy or dairy alternative beverage including, but not limited to, milk, cream, soy milk, or any combination thereof.

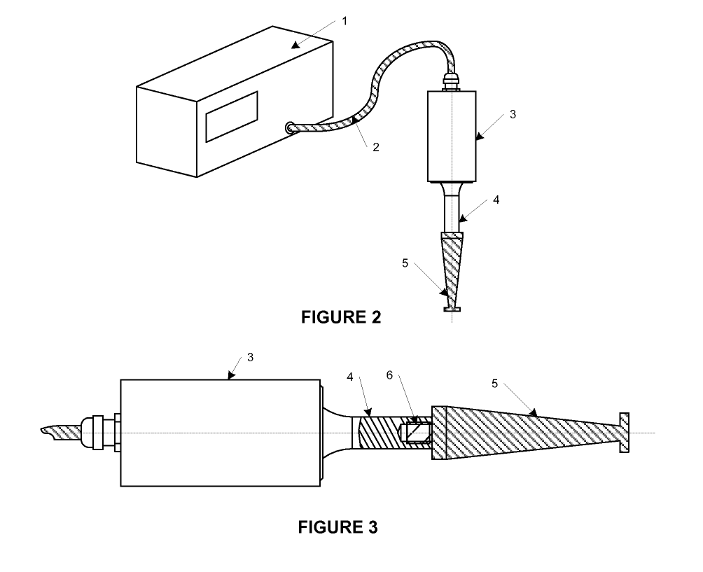

FIG. 2 is a perspective view of an ultrasound apparatus for use according to the present invention. The ultrasound apparatus is comprised of an ultrasound generator 1, a transducer cable 2, an ultrasound transducer 3, an ultrasound horn 4, and an ultrasound tip 5.

FIG. 3 is a cross-sectional view of the ultrasound apparatus shown in FIG. 1. The ultrasound apparatus is comprised of an ultrasound transducer 3, an ultrasound horn 4, and an ultrasound tip 5. The ultrasound horn 4 is mechanically connected to the ultrasound tip 5 by threading or other means 6. Alternative embodiments could have the ultrasound tip 5 directly connected to the ultrasound horn 4 to comprise a single piece without a mechanical interface. Alternatively, the ultrasound tip 5 could be connected to the ultrasound horn 4 by chemical bonding with an adhesive, by soldering, by wielding, or any combination thereof. The ultrasound transducer 3 is directly connected to the ultrasound horn 4; alternative embodiments could have the ultrasound transducer 3 mechanically connected to the ultrasound horn 4 by treading or other means. The ultrasound transducer 3 and horn 4 may also be connected by chemical bonding with an adhesive, by soldering, by wielding, or any combination thereof.

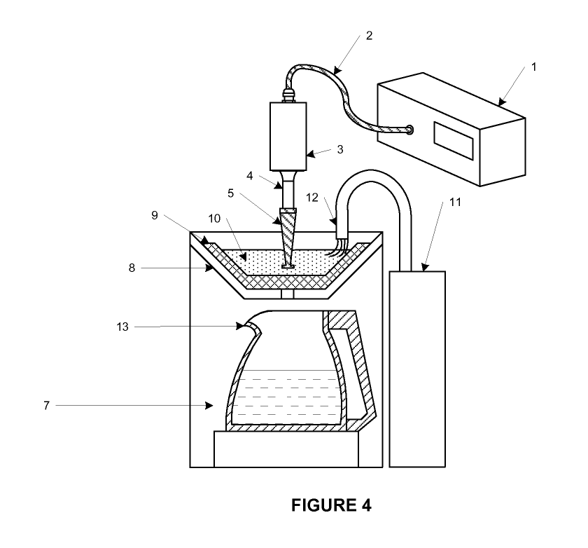

FIG. 4 is a schematic cross-sectional view of an ultrasound method and device for the production of beverages from coffee beans via a drip brew method. The ultrasound apparatus is comprised of an ultrasound generator 1, a transducer cable 2, an ultrasound transducer 3, an ultrasound horn 4, and an ultrasound tip 5. A brewing machine 7 may be used to produce beverages, which is comprised of a chamber 8, a coffee filter 9, coffee beans 10, a water reservoir 11, a supply port 12, and a collection reservoir 13. A coffee filter 9 is placed on a chamber 8, and then coffee beans 10 are placed on the coffee filter 9. Alternatively, filter 9 may completely line chamber 8 or a portion thereof. Filter 9 may also be integral with chamber 8. In the classic drip brewing method, water drips out of a supply port 12 and onto the coffee beans 10. Ultrasound tip 5, inserted into coffee beans 10, delivers ultrasound energy to coffee beans 10. Cavitating coffee beans 10 by delivering ultrasonic energy further grinds beans 10 while liberating flavor solutes and oils from coffee beans 10. Flowing through the coffee beans 10 the water collects oils and flavor solutes from the coffee beans 10, while simultaneously being sanitized by the ultrasound energy emitted from ultrasound tip 5. Water then drips through the coffee filter 9 and into the collection reservoir 13. Though the embodiment depicted in FIG. 3 delivers water to beans 10 by means of a water reservoir 11 separate from tip 5, other means of supplying water may be similarly effective. Water may also be delivered through an orifice (not shown) in an ultrasound tip 5.

In keeping with FIG. 4, ultrasound energy can be delivered before, during, or after the water drips onto the coffee beans 10, or any combination thereof. The ultrasound tip 5 may either stay in the same position during the delivery of ultrasound energy or may move during delivery of ultrasound energy. One method of movement is where the ultrasound tip 5 is inserted into the bottom of the coffee beans 10 and then the ultrasound tip 5 rises in a continuous motion as it delivers ultrasound energy. After the sonication begins, the ultrasound tip 5 gradually rises to the top of the coffee beans 10 while delivering ultrasound energy. The ultrasound tip 5 stops its movement and stops delivering ultrasound energy after it reaches the top of the coffee beans 10. Another method of movement is where the ultrasound tip 5 is inserted into the bottom of the coffee beans 9 and then the ultrasound tip 5 rises in a step-wise motion. After the ultrasound tip 5 is inserted into the coffee beans 10, sonication occurs for a brief time and then stops. The ultrasound tip 5 is moved slightly higher, and then sonication occurs again. This step-wise motion for delivering ultrasound energy is repeated until the ultrasound tip 5 has reached the top of the coffee beans 10 and/or until all of the coffee beans 10 have been sonicated. This distance between delivery steps in the step-wise delivery methods can be of equal or varying distances. In addition to a vertical motion, the tip may be moved in horizontal motion, circular motion, or any combination thereof. The motion may be continuous or step-wise.

In the embodiment depicted in FIG. 4, the ultrasound tip 5 is inserted into the coffee beans 10 during the delivery of ultrasound energy. The ultrasound tip 5 may also be placed above the coffee beans 10 as to deliver ultrasound energy without contacting the coffee beans 10, or the ultrasound tip 5 may be placed next to a coupling medium, such as the coffee holder 8 and coffee filter 9, and deliver the ultrasound energy through the coupling medium. When employing either delivery method, ultrasound tip 5 may be held stationary or moved in a continuous or step-wise fashion in either a circular, horizontal, or vertical motion or any combination thereof.

Another example of using ultrasound energy to produce a beverage is in the brewing of espresso. An ultrasound tip may deliver ultrasound energy to the coffee grounds as high pressure water strikes the coffee grounds and produces the espresso.

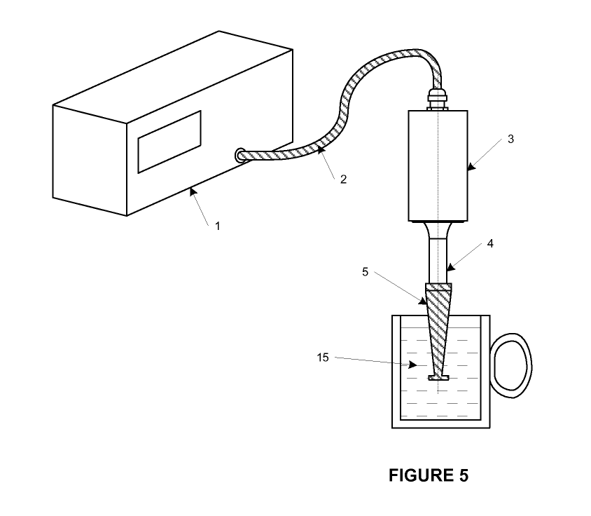

FIG. 5 is a cross-sectional view of an ultrasound tip 5 sonicating a mixture of espresso and milk 15 in order to produce cappuccino. Regular espresso or ultrasound-produced espresso may be poured into a cup with milk; the espresso may be poured before, during, or after the pouring of the milk, or any combination thereof. Ultrasound tip 5 is then inserted into mixture 15. Ultrasound tip 5 then delivers ultrasound energy in order to sonicate the mixture 15 and produce cappuccino. The ultrasound energy may be delivered either from direct insertion into the mixture 15, without contacting the mixture 15, or through a coupling medium such as the cup containing the mixture 15. When directly inserted, ultrasound tip 5 may be moved in a continuous or step-wise horizontal, vertical, or circular motion or any combination thereof. The ultrasound energy may have multiple effects such as sanitizing the beverage, mixing the espresso and milk, heating the milk, or producing milk froth through cavitation, or any combination thereof. Cappuccino may be produced by using ultrasound energy to brew espresso, then mix the espresso with milk, and then sonicate the mixture 15 of espresso and milk by directly inserting the ultrasound tip 5. Another method is that espresso and milk may both be sonicated separately, and then the espresso and milk can be mixed; sonication may occur again after the espresso is mixed with the milk. Furthermore, ultrasound may be delivered during the espresso production so that sonication occurs while pressurized water or steam and milk are delivered to the coffee beans. In another embodiment, the milk and/or water or steam can be delivered through an orifice or orifices in the ultrasound tip (not shown). These are only examples of possible production methods; other methods may be similarly effective.

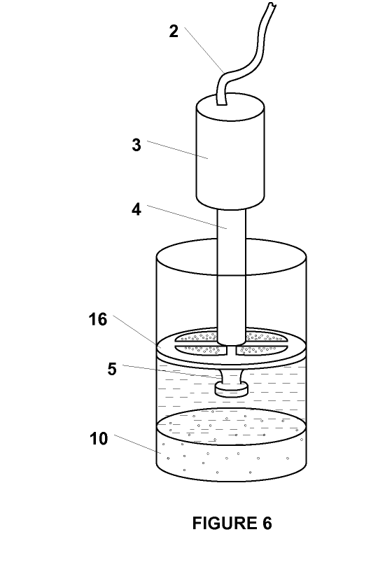

Depicted in FIG. 6 is an alternative embodiment of the present invention in which a French press, or coffee press, has been adapted to incorporate the present invention. This embodiment comprises a chamber 8 wherein coffee beans 10 are exposed to water. The embodiment further comprises a filter 16 that may be attached to tip 5 and/or horn 4. Producing beverages from coffee beans with this embodiment comprises the steps of placing water, either hot or cold, and coffee beans into chamber 8. Inserting tip 5 into chamber and emitting ultrasound energy from said tip, following the addition coffee beans 10, exposes coffee beans 10 to ultrasound energy. Pushing tip 5 towards the bottom of chamber 8 separates the water from coffee beans 10. As filter 16, attached to tip 5 and/or horn 4, advances towards the bottom of chamber 8, water flows through filter 16 while coffee beans 10 remain below filter 16. Filter 16 need not be attached to tip 5 and/or horn 4, but rather may be attached to a separate shaft of suitable length. In such an alternative embodiment, after coffee beans 10 have been exposed to water and ultrasound energy emitted from tip 5, tip 5 is removed from chamber 8 and then filter 16 is pushed towards the bottom of chamber 8.

A further example of using ultrasound energy to produce a beverage from coffee beans is using ultrasound energy in the production of instant coffee so that ultrasound energy is delivered after hot water is mixed with the instant coffee. The examples listed here regarding the use of ultrasound energy in the production of beverages from coffee beans are not exhaustive; ultrasound energy may also be utilized in the production of other beverages from coffee beans and may be utilized in other manners.

The ultrasound frequency range for use in the above described methods and apparatuses is approximately 15 kHz to 20 MHz, with a preferred ultrasound frequency range of approximately 25 kHz-100 kHz, and the recommended ultrasound frequency value is approximately 30 kHz. The ultrasound amplitude can be approximately 1 micron and above, with a preferred ultrasound amplitude range of approximately 20 microns to 100 microns, and the recommended ultrasound amplitude value of approximately 50 microns. The duration of the delivery of ultrasound energy will vary based on a variety of factors. These factors include, but are not limited to, the amount of coffee beans used, the amount of beverage being produced, and the type of beverage being produced

The use of ultrasound energy in the production of beverages from coffee beans may have multiple benefits such as the extraction of more flavor from the coffee beans and the sterilization of the beverage by the removal of potentially harmful microorganisms from the coffee beans and the water.

Although specific embodiments and methods of use have been illustrated and described herein, it will be appreciated by those of ordinary skill in the art that any arrangement that is calculated to achieve the same purpose may be substituted for the specific embodiments and methods shown. It is to be understood that the above description is intended to be illustrative and not restrictive. Combinations of the above embodiments and other embodiments as well as combinations of the above methods of use and other methods of use will be apparent to those having skill in the art upon review of the present disclosure. The scope of the present invention should be determined with reference to the appended claims, along with the full scope of equivalents to which such claims are entitled.

I claim:

1. A method for producing beverages from coffee beans, comprising the steps of:
a. Exposing coffee beans to water; and
b. Delivering ultrasound energy to coffee beans.

2. The method according to claim 1, wherein said delivery of ultrasound energy to coffee beans occurs simultaneously with said exposure of coffee beans to water.

3. The method according to claim 1, wherein said delivery of ultrasound energy to coffee beans occurs prior to said exposure of coffee beans to water.

4. The method according to claim 1, further comprising the step of separating said water from said coffee beans.

5. The method according to claim 4, wherein said separation of water from coffee beans is accomplished by filtering said beans from said water.

6. The method according to claim 6, further comprising the step of collecting said water separated from said beans.

7. The method according to claim 1, further comprising the step of generating milk froth.

8. The method according to claim 7, wherein said generation of milk froth is accomplished by delivering ultrasound energy to milk.

9. The method according to claim 1, further comprising the step of adding milk.

10. The method according to claim 1, further comprising the step of adding milk froth.

11. The method according to claim 1, further comprising the step of steaming milk.

12. The method according to claim 1, further comprising the step of adding steamed milk.

13. The method according to claim 1, wherein said transducer operates at a frequency of approximately 15 kHz to 20 MHz.

14. The method according to claim 1, wherein said transducer operates at a preferred frequency of approximately 25 kHz to 100 kHz.

15. The method according to claim 1, wherein said transducer operates at a frequency of approximately 30 kHz.

16. The method according to claim 1, wherein said transducer displaces at an amplitude of at least 1 micron.

17. The method according to claim 1, wherein said transducer displaces at an amplitude of approximately 20 to 100 microns.

18. The method according to claim 1, wherein said transducer displaces at an amplitude of approximately 50 microns.

19. The method according to claim 1, wherein said delivery of ultrasound to coffee beans occurs for a period of approximately 1 second to 1 minute.

20. The method according to claim 1, where said delivery of ultrasound to coffee beans occurs for a period of approximately 10 seconds.

21. A method for producing beverages from coffee beans, comprising:
a. Exposing coffee beans to water;
b. Separate water from beans;
c. Collect separated water;
d. Add milk to collected separate water; and
e. Deliver ultrasound energy to the collected separated water and milk.

22. An apparatus for producing beverages from coffee beans, comprising:
a. A generator;
b. A transducer;
c. A horn;
d. An ultrasound tip;
e. Chamber;
f. Wherein coffee beans are exposed to water within said chamber; and
g. Wherein said tip delivers ultrasound energy to coffee beans.

23. The apparatus according to claim 22, further comprising a filter.

24. The apparatus according to claim 23, wherein said filter is attached to said horn.

25. The apparatus according to claim 23, wherein said filter is attached to said tip.

26. The apparatus according to claim 23, wherein said filter lines all or a portion of said chamber.

27. The apparatus according to claim 23, wherein said filter is integral with said chamber.

28. The apparatus according to claim 23, further comprising a shaft connected to said filter.

29. The apparatus according to claim 22, further comprising a water reservoir.

30. The apparatus according to claim 22, further comprising a collection reservoir.

31. The apparatus according to claim 22, wherein said transducer operates at a frequency of approximately 15 kHz to 20 MHz.

32. The apparatus according to claim 22, wherein said transducer operates at a preferred frequency of approximately 25 kHz to 100 kHz.

33. The apparatus according to claim 22, wherein said transducer operates at a recommended frequency of approximately 30 kHz.

34. The apparatus according to claim 22, wherein said transducer displaces at an amplitude of at least approximately 1 micron.

35. The apparatus according to claim 22, wherein said transducer displaces at an amplitude of approximately 20 to 100 microns.

36. The apparatus according to claim 22, wherein said transducer displaces at an amplitude of approximately 50 microns.
